(19) United States
(12) Patent Application Publication
(10) Pub. No.: US 2007/0083888 A1
(43) Pub. Date: Apr. 12, 2007

(54) Method and apparatus for setting up video input information

(75) Inventor: Valerie Sacrez Liebhold, Indianapolis, IN (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(73) Assignee: THOMSON LICENSING INC., Princeton, NJ (US)

(21) Appl. No.: 10/576,432

(22) PCT Filed: Oct. 28, 2003
(86) PCT No.: PCT/US03/34217

§ 371 Date: Apr. 20, 2006

(51) Int. Cl. H04N 5/445; G06F 3/00; G06F 13/00; H04N 7/18

(52) U.S. Cl. 725/37; 725/38; 725/61; 725/80

(57) ABSTRACT

A television set includes a processor, memory, a number of video inputs and corresponding cable detectors for detecting the presence of a device coupled to a video input. The processor executes a set-up program stored in the memory. In particular, when the processor detects the presence of a device coupled to a particular video input, via one of the cable detectors, the processor, in response thereto, prompts a user to select one of a number of device labels to associate with the detected device.

### BACKGROUND OF THE INVENTION

The present invention generally relates to home entertainment systems and, more particularly, to a television set.

In setting up, or connecting, external peripheral devices such as a digital video disc (DVD) player, video cassette recorder (VCR), etc., to a television (TV) set, these devices are typically connected to the TV set though a number of video inputs. For example, the DVD player may be connected to a connector of video input 1, while the VCR is connected to a connector of video input 2, etc. In order to view video from these devices, the appropriate video input of the TV set must be selected by a user via, e.g., a video input mode key on a remote control device of the TV set. Typically, as a user presses the video input mode key, the TV set cycles through all of the available video inputs and, via the on-screen display (OSD), briefly displays the currently connected video input as a label. For example, when video input 1 is selected, the TV set will briefly show the label “Video Input 1” in, e.g., the upper right hand corner of the TV screen.

However, a user of the TV set may, or may not, be the same person who installed the peripheral devices. If the user is not the same person who installed the device, the user may be at a loss as to what video input to use when attempting to access, e.g., the DVD player. Further, even if the user is the same person who installed the peripheral device, the user may have difficulty remembering that, e.g., video input 1 is connected to the DVD player.

As such, it is known that a TV set can be manually re-configured by the user such that the label associated with a particular video input can be changed to represent a more meaningful abbreviation. Thus, when the user presses the video input mode key, the TV set steps through the video inputs, which are identified now as, e.g., “DVD,” “VCR,” etc., on the OSD.

While this simplifies subsequent user selection of a video input, it still does not resolve that initial selection of the video input, when the OSD still displays the default labels of “Video Input 1,” etc. Further, the ability to manually change the labels assumes that someone will re-define the default labels to meaningful abbreviations in the first place—which may not occur—and/or that the instructions for manually changing the labels are viewed by the user as simple to perform—which also may not be the case.

### SUMMARY OF THE INVENTION

In view of the above, I have realized a method that simplifies the set up of home entertainment products, or peripheral devices, when connecting them to a video input switching device, such as a TV set. In particular, and in accordance with the principles of the invention, the video input switching device detects a device coupled to a video input of the video input switching device and, in response thereto, prompts the user to select one of a number of device labels to associate with the detected device.

In an embodiment of the invention, the video input switching device is a TV set including a processor, memory, a number of video inputs, and corresponding cable detectors for detecting the presence of a device coupled to a video input. The processor executes a set-up program stored in the memory. In particular, when the processor detects the presence of a device coupled to a particular video input, via one of the cable detectors, the processor, in response thereto, prompts a user to select one of a number of device labels to associate with the detected device. As a result, the user is prompted to automatically configure the video input of the TV set, which simplifies both the initial set up thereof and subsequent selection of a video input mode.

### BRIEF DESCRIPTION OF THE DRAWINGS

FIG. 1 shows an illustrative home entertainment system embodying the principles of the invention;

FIG. 2 shows an illustrative television set in accordance with the principles of the invention;

FIG. 3 shows an illustrative data structure for use in the television of FIG. 2;

FIG. 4 shows an illustrative flow chart in accordance with the principles of the invention;

FIG. 5 shows an illustrative on-screen display in accordance with the principles of the invention;

FIG. 6 is another illustration of the data structure of FIG. 3;

FIGS. 7, 8 and 9 show other illustrative flow charts in accordance with the principles of the invention;

FIG. 10 shows another illustrative on-screen display in accordance with the principles of the invention; and

FIGS. 11 and 12 show other illustrative flow charts in accordance with the principles of the invention.

### DETAILED DESCRIPTION

Other than the inventive concept, the elements shown in the figures are well known and will not be described in detail. For example, other than the inventive concept, a television and the components thereof, such as a cable detector, remote control, etc., are well known and not described in detail herein. In addition, the inventive concept may be implemented using conventional programming techniques, which, as such, will not be described herein. Finally, like-numbers on the figures represent similar elements.

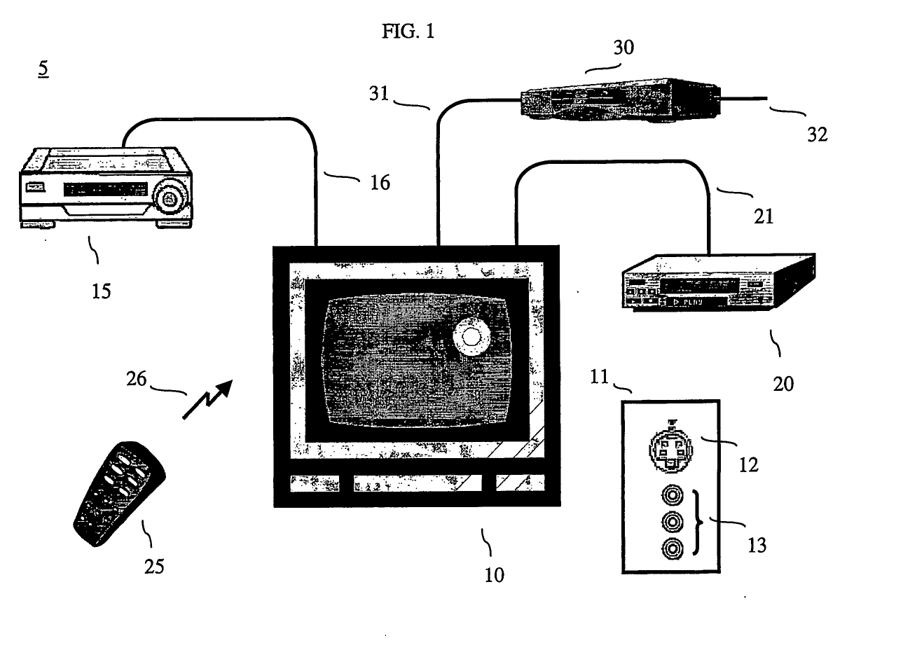

An illustrative home entertainment system 5 in accordance with the principles of the invention is shown in FIG. 1. Home entertainment system 5 includes a number of external peripheral devices as represented by VCR 15, DVD player 20 and set-top box 30, a video input switching device as represented by TV set 10 and a remote control device 25. The latter provides control signals, e.g., via infra-red (IR) signal 26 to TV set 10, for issuing any one of a number of commands to the TV set, e.g., power-on, power-off, channel selection, video input mode selection, etc. It should be noted that, although not necessary for the inventive concept, remote control device 25 may also control one, or more, of the peripheral devices. Set-top box 30 is coupled, via cable 32, to, e.g., a satellite antenna (not shown) or a cable system head-end (not shown) for receiving programming content therefrom. Although not required for the invention, set-top box 30 may also be coupled to, e.g., the public-switched telephone network (PSTN).

VCR 15, DVD player 20 and set-top box 30 are each coupled to a respective connector, or jack, of a video input of TV set 10 via cabling 16, 21 and 31, respectively. For example, VCR 15 is connected to a connector of video input 1, while DVD player 20 is connected to a connector of video input 2, and set-top box 30 is connected to a connector of video input 3. Illustratively, cabling 16, 21, 31 and 32 are representative of any connecting means such as, but not limited to, coaxial cable, optical cable, audio/video (A/V) cable, composite video cable, super video (S-video) cable, luminance and chrominance (Y & C) video cable, component (Y, P_{B}, P_{R}) video cable, red-blue-green (RGB) video cable, etc. Obviously, the respective peripheral device and the TV set include therein the corresponding electrical connectors (not shown) for connecting to the respective cable. For example, if an S-video cable is used to connect to TV set 10, then TV set 10 must have an S-video connector (unless a converting device/cable (not shown) is used to convert to the appropriate type of electrical connector). In this regard, it should be noted that a video switching device, such as represented by TV set 10, may have a number, or block, of electrical connectors associated with each video input. For example, video input 1 may include a block of electrical connectors such as, but not limited to, a coaxial cable connector, an RGB connector, etc. An illustrative block 11 for a video input is also shown in FIG. 1 and comprises two types of connectors: S-video connector 12 and A/V connectors 13. Further, although described in the context of “wired” connections, the connections between a peripheral device and the video input switching device may be wireless. As such, the term “cable” as used herein refers to both wired and wireless connections.

When a user of home entertainment system 5 wants to, e.g., view a movie from DVD player 20, the user must first select via, e.g., remote control device 25, the video input corresponding to the connector coupled to DVD player 20. In this example, the user must select video input 2. However, as noted earlier, mere selection of the correct video input by the user may be problematic. As such, I have realized a method that simplifies the set up of home entertainment products, or peripheral devices, when connecting them to a video input switching device, such as a TV set. In particular, and in accordance with the principles of the invention, the video input switching device detects a device coupled to a video input of the video input switching device and, in response thereto, prompts the user to select one of a number of device labels to associate with the detected device. As a result, the user is prompted to automatically configure the video inputs of the TV set, which simplifies both the initial set up thereof and subsequent selection of a video input mode.

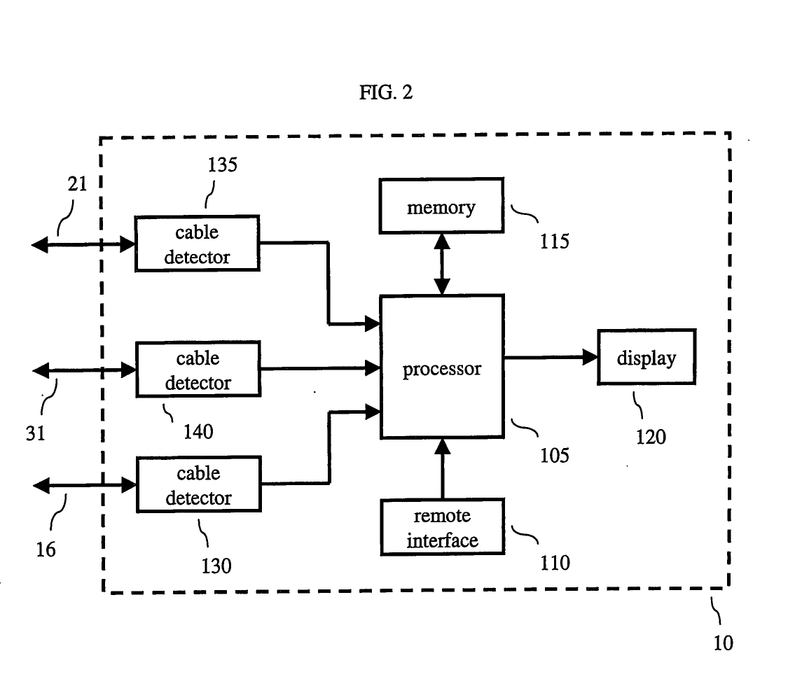

Turning now to FIG. 2, an illustrative TV set 10 in accordance with the principles of the invention is shown. It should be noted that only those elements of TV set 10 relevant to the principles of the invention are shown. TV set 10 comprises a number of cable detector circuits as represented by cable detectors 130, 135 and 140, a processor 105, a memory 115, display 120 and remote interface 110, which receives the above described signaling from remote control device 25. Display 120 is representative of any one of a number of display technologies, e.g., a plasma display, rear projection TV, front projection TV, tube-based, etc. and includes not only the display element itself but also the requisite elements for displaying images, or pictures, on the particular type of display. Processor 105 is a stored-program-controlled processor, e.g., a microprocessor, that executes a program, or programs, stored in memory 115, which may be internal and/or external to processor 105 and is volatile and/or non-volatile, as necessary. As can be observed from FIG. 2, processor 105 receives signals from the cable detectors 130, 135 and 140, and remote interface 110, and provides signals, e.g., data, for viewing on display 120. TV set 10 includes N video inputs, where N ≧1, each video input associated with one of the cable detectors. For example, cable detector 130 is associated with video input 1, cable detector 135 with video input 2 and cable detector 140 with video input 3. For the purposes of this example only three video inputs are shown in FIG. 2 and it is assumed that cable detectors 130, 135 and 140 not only provide an indication to processor 105 if a cable/peripheral device has been connected to a connector of a respective video input of TV set 10 but also provide an indication to processor 105 when a signal is detected on the respective cable.

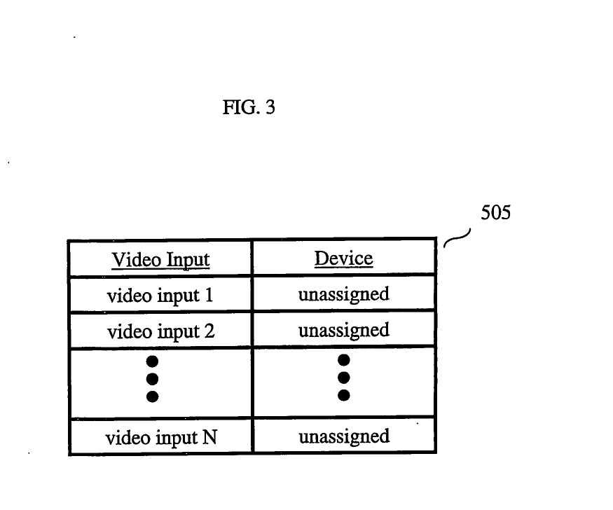

Reference should now also be made to FIGS. 3, 4, 5 and 6, which along with FIG. 2, further illustrate the principles of the invention. For the purposes of this example, it is assumed that initially none of the video inputs of TV set 10 have been allocated to a particular peripheral device. In particular, that cables 16, 21 and 31 are, for the moment, not connected to TV set 10. As such, upon powering up TV set 10, a data structure stored in memory 115, such as illustrative table 505 shown in FIG. 3, is initially predefined to indicate that none of the N video inputs have been assigned to a peripheral device. For example, “video input 1” of table 505 is associated with the entry “unassigned.” Consequently, if a user should press a video input mode key of remote control device 25, processor 105 of TV set 10 (upon receipt of the command via remote interface 110) merely displays the default labels associated with the respective video input on display 120. For example, the default labels may be “Video Input 1,” “Video input 2,” etc., corresponding to video input 1, video input 2, etc. These default labels may be stored in memory 115.

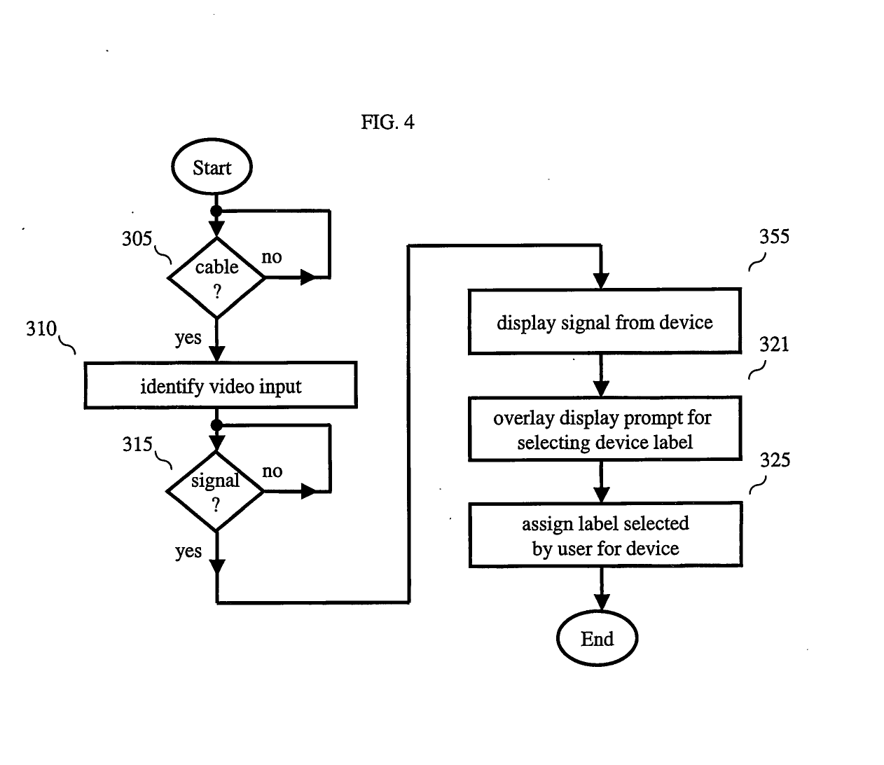

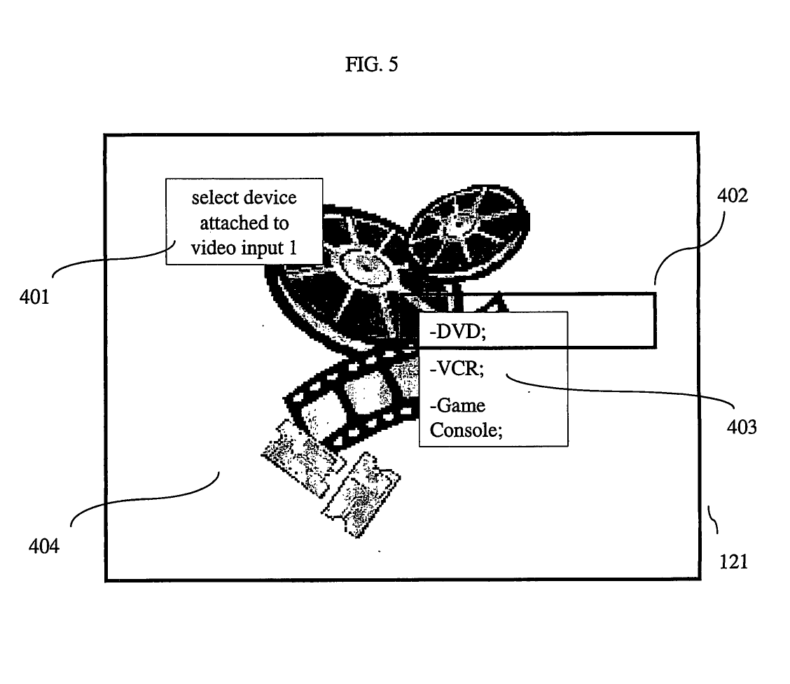

Turning now to FIG. 4, an illustrative flow chart is shown in accordance with the principles of the invention. In the description that follows, TV set 10 automatically detects the presence of a peripheral device and prompts the user to assign a context-related label to the device. At the start, in step 305, TV set 10 waits for detection of a cable via one of the cable detectors. This step may be accomplished, e.g., via an interrupt mode of operation or a polling mode of operation. For example, assume that the user connects cable 16 to TV set 10. As a result, cable detector 130 provides an interrupt to processor 105 signaling that a cable has been detected in step 305. Since the interrupt came from cable detector 130, processor 105 identifies the video input as video input 1 in step 310. In step 315, TV set 10 waits for detection of a signal on the cable connected to video input 1. Upon detection of a signal, via cable detector 130, processor 105 displays the video signal being received from the identified video input on display 120 in step 355. This is illustrated in FIG. 5 by image 404, which depicts a movie reel and tickets. In this regard, image 404 is representative of an image from the attached peripheral device, e.g., image 404 may be a logo identifying the type and manufacturer of the peripheral device, or an image from content currently loaded into, and or being received by, the peripheral device. As used herein, content means any audio/visual material including programming content (movies, electronic programming guide, menus, etc) as, e.g., provided by a satellite or cable provider, etc.; or stored on a medium, e.g., a DVD or cassette tape, etc. Then, in step 321, and as illustrated in FIG. 5, processor 105 overlays an illustrative OSD as represented by image 121 over image 404 on display 120 for viewing by the user. Image, or picture, 121 includes a prompt 401, a cursor 402 and a list 403. Prompt 401 illustratively includes text that prompts the user to select the device attached to the identified video input, here video input 1, by movement of cursor 402 over one of the labels in list 403. The latter includes a number of predefined device labels such as, but not limited to: “DVD,” “VCR,” Game Console,” etc. The user moves cursor 402 via respective buttons (not shown) on remote control device 25. Likewise, the user also signals selection to processor 105 of one of the labels of list 403 currently under cursor 402 for assignment to the peripheral device. In this example, the user, via remote control device 25, positions cursor 402 over the VCR label of list 403 and indicates selection thereof. In response to the selection indication received via remote interface 110 of TV set 10, processor 105 assigns the selected label to the identified video input in step 325 of FIG. 4 and modifies table 505 to now indicate that video input 1 has assigned thereto the label “VCR.” Thus, a meaningful name is easily assigned to a peripheral device without the user having to remember either how to manually assign a label to the device or what video input is coupled to the device. Indeed, the use of the input video signal (as represented by image 404 of FIG. 5) from the identified video input further enables the user to quickly identify the peripheral device associated with the video input for selecting the appropriate label from list 403 in step 325. It should also be noted that, for simplicity, error conditions are not shown in the flow charts described herein. For example, should processor 105 lose cable detection while waiting for signal detection in step 315, the above described process is restarted; or, should the user not respond in step 325, the process is aborted after expiration of a predefined time-out.

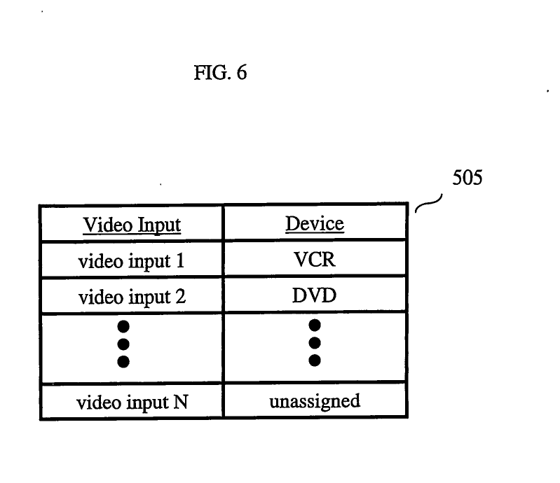

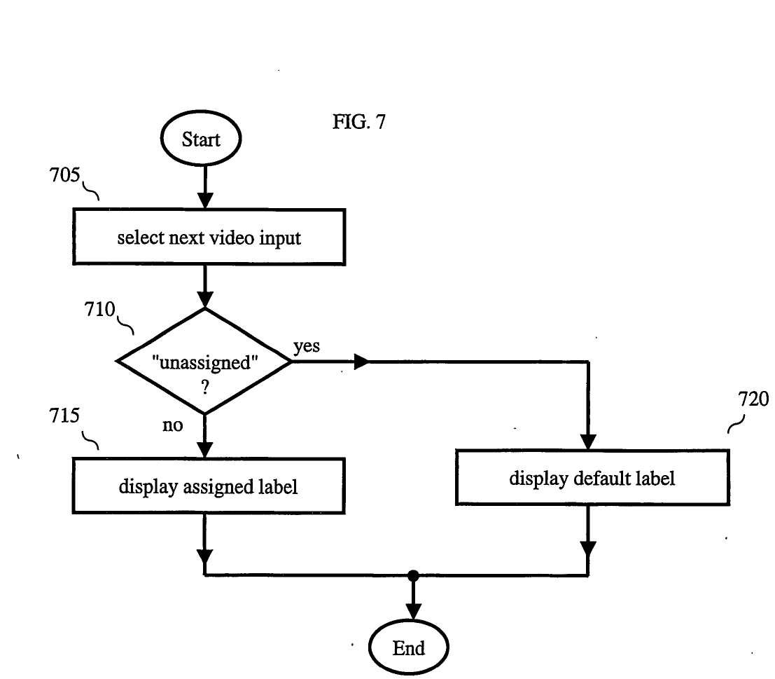

The above described procedure is performed for one or more of the N video input connectors of TV set 10. In this regard, table 505 is shown again in FIG. 6 after video input 1 and video input 2 have both been assigned via the above described method. As a result, subsequent selection by the user of a particular video input mode is simplified by the use of the context-related labels shown in table 505 of FIG. 6. In particular, FIG. 7 shows an illustrative flow chart for execution by processor 105 for displaying the appropriate video input labels. In response to a video input mode command received from remote control device 25, processor 105 changes the currently selected video input to the next video input in step 705. For example, if the currently selected video input is video input 1, upon receipt of the video input mode command, processor 105 changes the selected video input to video input 2 in step 705. In step 710, processor 105 determines if video input 2 is currently indicated as “unassigned” in table 505. If so, processor 105 causes the default label, e.g., “Video Input 2” to be displayed on display 120 in step 720. On the other hand, if, e.g., table 505 indicates that video input 2 is not “unassigned,” then processor 105 causes the label stored in table 505, e.g., “DVD” to be displayed on display 120 in step 715.

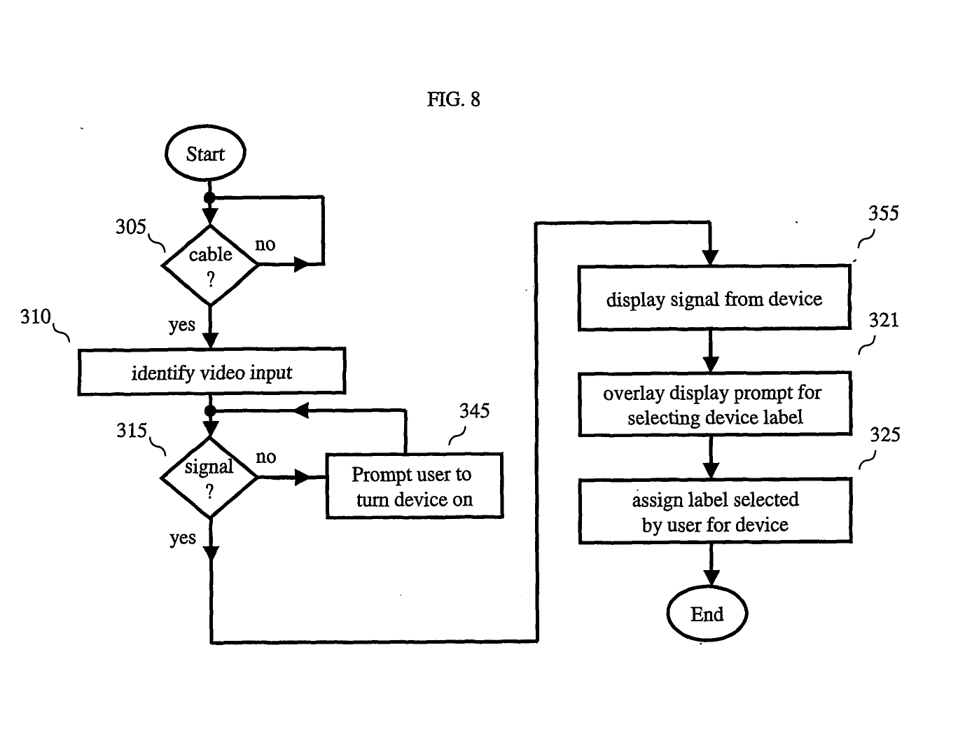

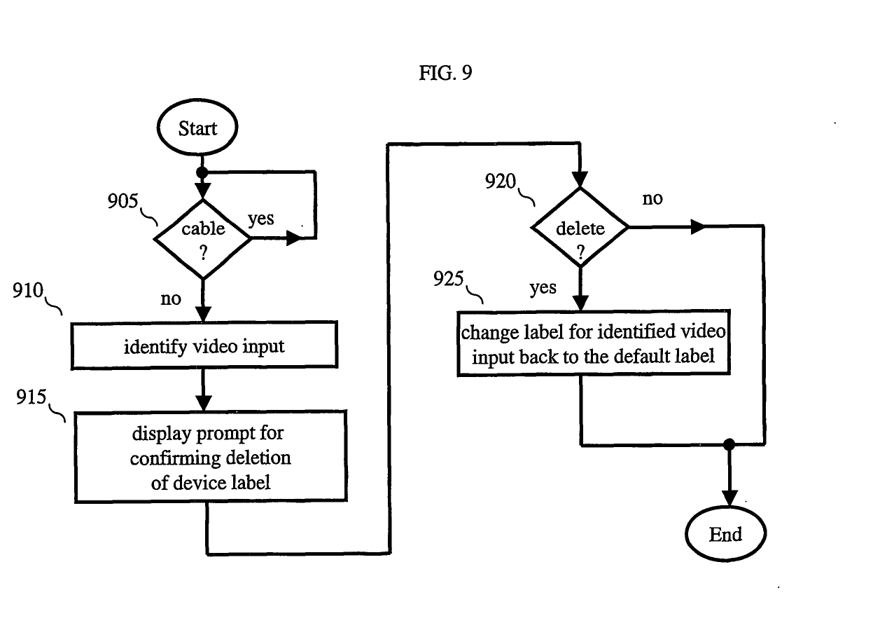

Other modifications may be made in accordance with the inventive concept. For example, the detection of a cable alone, or the detection of a signal alone, may be used to initiate the automatic configuration described herein. Further, display of the video signal from the identified video input, while preferred, is not required. Also, if a user assigns the same type of device to more than one video input, e.g., the user assigns “DVD” to both video input 1 and video input 2, processor 105 may automatically append a suffix to each label such that, e.g., the label “DVD 1” is displayed for video input 1 and the label “DVD 2” is displayed for video input 2. Such a suffix can either be added directly to the data structure illustrated by table 505 or appended to the context-related label from table 505 “on-the-fly” before processor 105 causes the context-related label to be shown on display 120. In addition, another variation is shown in the flow chart of FIG. 8, which illustrates a process similar to the one described above for FIG. 4 with the addition of step 345. In this latter step, processor 105 now prompts the user via display 120 to ensure that the device is turned on if no signal is detected in step 315. Further, the above described process can be modified to accommodate a subsequent disconnect of a cable from a connector of a video input that already has a context-related label associated therewith. This is illustrated in the flow chart of FIG. 9.

In step 905, TV set 10 waits for detection of a cable disconnect via one of the cable detectors. Like step 305 of FIG. 4, this step may be accomplished, e.g., via an interrupt mode of operation or a polling mode of operation. For example, assume that the user disconnects cable 16 from TV set 10. As a result, cable detector 130 provides an interrupt to processor 105 signaling that a cable has been removed in step 905. Since the interrupt came from cable detector 130, processor 105 identifies the video input as video input 1 in step 910.

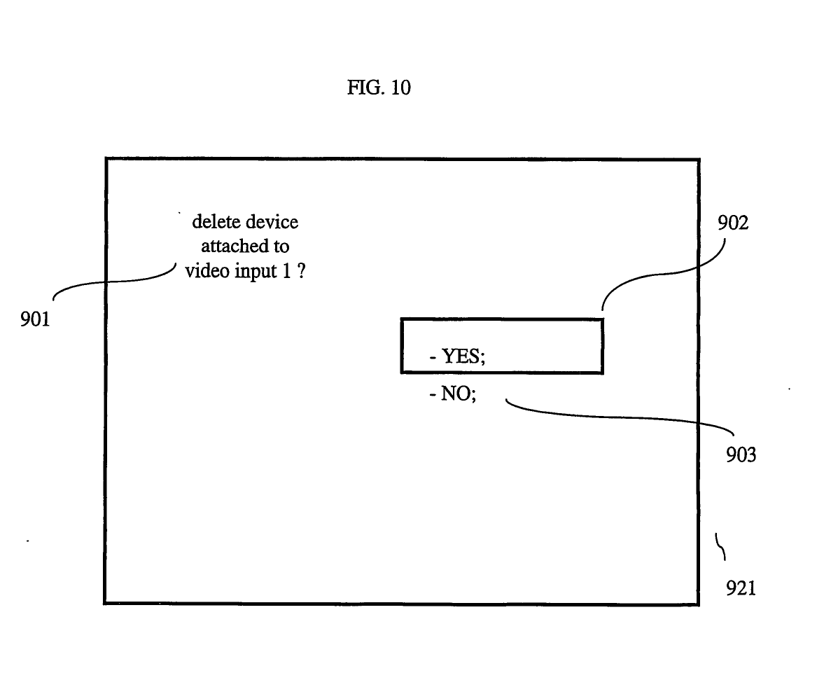

In step 915, processor 105 displays a prompt on display 120 for viewing by the user. An illustrative picture, or image, 921 for use as an OSD is shown in FIG. 10. Image 921 includes a prompt 901, a cursor 902 and a list 903. Prompt 901 illustratively includes text that prompts the user to confirm deletion of the device attached to the identified video input, here video input 1, by movement of cursor 902 over one of the response choices in list 903, either “YES” or “NO.” The user moves cursor 902 via respective buttons (not shown) on remote control device 25. Likewise, the user also signals selection to processor 105 of one of the responses of list 903 currently under cursor 902 for assignment to the peripheral device. If the user selects “NO,” in step 920 of FIG. 9, then processor 105 does not alter the associated label for the identified video input. On the other hand, if the user selects “YES,” in step 920, then processor 105 changes the label for the identified video input back to the default label associated therewith in step 925. It should be noted that whatever the user selects, the earlier described flow chart of FIG. 4 is executed when the user re-connects a cable to the video input to automatically provide the user with the opportunity to change the label associated with the video input. Of course, should TV set 10 support the capability, the user may always manually edit the label as known in the art.

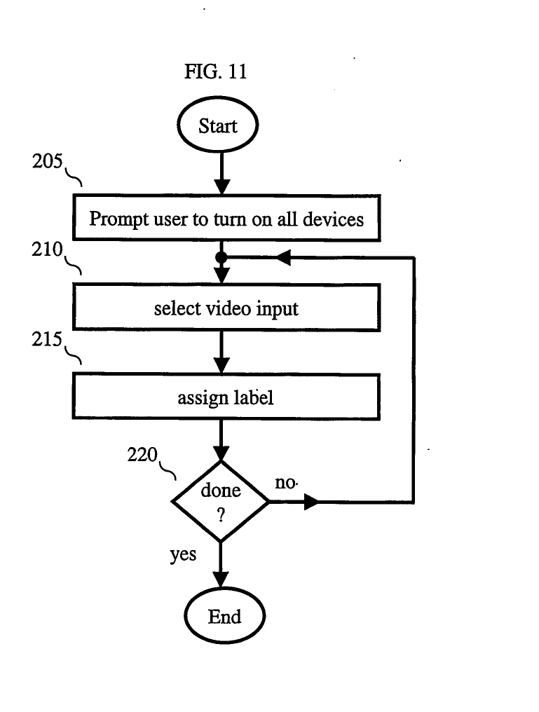

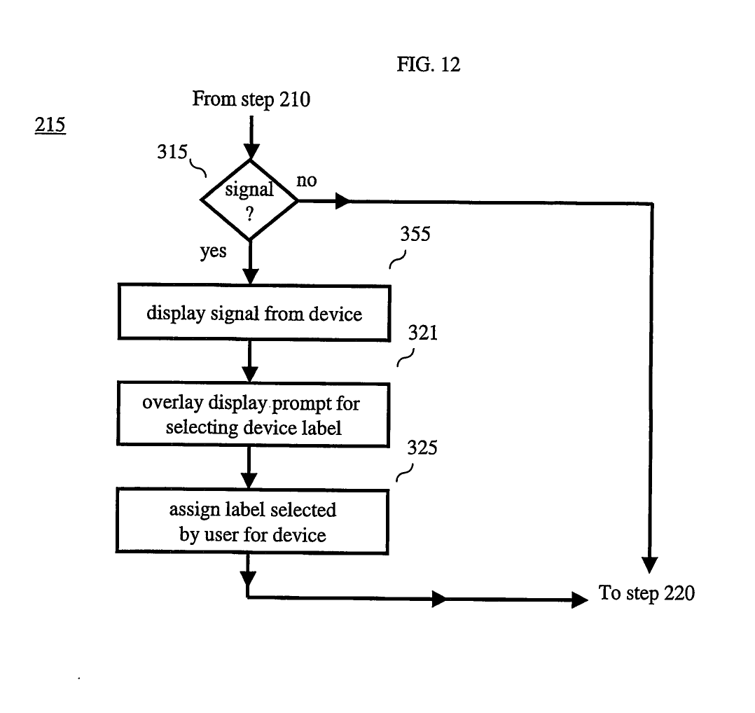

Another variation in accordance with the principles of the invention is shown in FIG. 11, which shows another illustrative flow chart for use in automatically configuring all of the attached devices. Such an automatic configuration mode may be entered via a separate set-up command of the TV set or upon the initial set-up of the TV set. In step 205, TV set 10 prompts the user via the OSD to turn on all connected devices. In step 210, TV set 10 selects one of the N video inputs, e.g., video input 1. In step 215, TV set 10 assigns a context-related label as described above. In step 220, TV set 10 checks if all of the N video inputs have been processed. If not, execution returns to step 210 to select the next video input. However, if all of the N video inputs have been processed, the procedure ends. As further illustration, an illustrative flow chart for step 215 is shown in FIG. 12. This flow chart is similar to the flow charts described above, as such similar steps have identical numbers. In step 315, TV set 10 waits for detection of a signal on the cable connected to the selected video input. If no signal is detected, e.g., upon expiration of a predetermined time-out, TV set 10 simply goes to step 220 to continue processing any remaining video inputs. However, upon detection of a signal, TV set 10 displays the video signal being received from the selected video input in step 355. Then, in step 321, TV set 10 overlays image 121 over image 404 from the video signal as illustrated in FIG. 4 and described above. In step 325, TV set 10 assigns the label selected by the viewer and execution proceeds to step 220.

Although the inventive concept was described in the context of a TV set, the inventive concept is not so limited and applies to the configuration of peripheral devices when connecting them to any type of video input switching device such as, but not limited to, a TV set, monitor, audio-video receiver, etc. Further, although shown as elements bundled within TV set 10, the elements therein may be distributed in different units in any combination thereof. For example, the video inputs and processor 105 may be a physically stand-alone device separate from display 120 such that processor 105 is coupled via a wired, or wireless, interface to display 120, etc. In addition, although the inventive concept was described in terms of using an OSD to provide visual prompts to the user, audio, e.g., voice prompting, may also be used instead of, or in addition to the OSD. For example, when processor 105 displays text prompt 401 on display 120, processor 105 may also play a stored audio file, or audio recording, from memory 115 through a speaker (not shown) of TV set 10 to provide an audio cue to the user. Alternatively, TV set 10 may synthesize the audio cue.

As such, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied on one or more integrated circuits (ICs). Similarly, although shown as separate elements, any or all of the elements of may be implemented in a stored-program-controlled processor. It is therefore to be understood that numerous modifications may be made to the illustrative embodiments and that other arrangements may be devised without departing from the spirit and scope of the present invention as defined by the appended claims.

1. A method for use in a video input switching device for configuring devices coupled thereto, the method comprising:
detecting a device coupled to a video input of the video input switching device; and
prompting a user to select a label for the detected device, wherein the label associates the detected device with the video input.

2. The method of claim 1, wherein the detecting step includes the step of detecting a cable coupled to the video input.

3. The method of claim 1, wherein the detecting step includes the step of detecting a signal received through the video input.

4. The method of claim 3, wherein the detecting a signal step includes the step of prompting the user to turn on the device if no signal is initially detected.

5. The method of claim 1, wherein the video input switching device is a television set.

6. The method of claim 1, wherein the prompting step includes the step of playing an audio cue to the user.

7. A method for use in a video input switching device for configuring devices coupled thereto, the method comprising:
detecting a device coupled to a video input of the video input switching device;
responsive to the detected device, displaying a picture for prompting a user to select a label for use in associating the detected device with the video input; and
receiving a response from the user to select the label that associates the detected device with the video input.

8. The method of claim 7, wherein the detecting step includes the step of detecting a cable coupled to the video input.

9. The method of claim 7, wherein the detecting step includes the step of detecting a signal received through the video input.

10. The method of claim 9, wherein the detecting a signal step includes the step of prompting the user to turn on the device if no signal is initially detected.

11. The method of claim 7, wherein the video input switching device is a television set.

12. The method of claim 7, wherein the displaying a picture step includes the step of displaying an image derived from a video signal received from the detected device such that the picture is overlaid over the image.

13. A method for use in a video input switching device, the video input switching device including a number of video inputs, the method comprising:
prompting a user to turn on each one of a number of peripheral devices coupled to the video input switching device; and
selecting, in turn, each one of the number of video inputs and prompting the user to select a label from a list of labels for associating the selected video input with a particular type of peripheral device.

14. The method of claim 13, wherein the prompting step is only performed if a signal is first detected on the selected video input.

15. The method of claim 13, wherein the video input switching device is a television set.

16. A method for use in a video input switching device, the method comprising:
storing in memory a table comprising a plurality of entries, where at least one entry associates a label with a video input of the video input switching device, wherein the label identifies a device connected to the video input;
detecting a disconnect from the video input switching device of a device entered in the table; and
prompting a user to confirm deletion from the table of the disconnected device and the label associated therewith.

17. The method of claim 16, wherein the video input switching device is a television set.

18. The method of claim 16, wherein the prompting step includes the step of playing an audio cue to the user.

19. A home entertainment system comprising:
a peripheral device; and
a video input switching device having at-least-one video input and coupled to the peripheral device through the at-least-one video input, wherein the video input switching device automatically prompts a user to select a label for the peripheral device upon detection of the peripheral device through the at-least-one video input.

20. The home entertainment system of claim 19, wherein the video input switching device detects the peripheral device by detecting a cable connected to the at-least-one video input.

21. The home entertainment system of claim 19, wherein the video input switching device detects the peripheral device by detecting a signal received through the at-least-one video input.

22. A video input switching device comprising:
a processor;
a memory for storing a list of labels, at least some of the labels representing a possible peripheral device that may be coupled to the video input switching device;
a display; and
a number of video inputs;
wherein the processor automatically displays the list of labels and prompts the user to select from the displayed list when the processor detects that a peripheral device has been connected thereto through at least one of the number of video inputs.

23. The video input switching device of claim 22, wherein the processor, memory, display and the number of video inputs are a part of a television set.

24. The video input switching device of claim 22, further including at least one cable detector and wherein the processor detects that a peripheral device has been connected thereto when the cable detector detects a cable being connected to the respective video input.

25. The video input switching device of claim 22, further including at least one cable detector and wherein the processor detects that a peripheral device has been connected thereto when the cable detector detects a signal is being received from the respective video input.
